(19) United States
(12) Patent Application Publication
(10) Pub. No.: US 2008/0227462 A1
(43) Pub. Date: Sep. 18, 2008

(54) Methods and Apparatus for Locating Access Device

(75) Inventors: Phillip Kent Freyman, Elgin, IL (US); Gordon B. Beacham, San Diego, CA (US); Robert C. Stein, Coopersburg, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/685,424

(22) Filed: Mar. 13, 2007

(51) Int. Cl. G06F 19/00; G01B 15/00

(52) U.S. Cl. 455/456.1; 702/127; 702/155; 702/158

(57) ABSTRACT

A system obtains a plurality of locations respectively associated with a plurality of mobile devices that are in communication with the stationary access device. For each of the plurality of mobile devices, the system obtains a relative distance metric associated with that mobile device. Based on the plurality of locations and the relative distance metric, the computes a relative location of the stationary access device.

### BACKGROUND

Conventional computerized devices, such as personal computers, laptop computers, and the like provide Voice over Internet Protocol (VoIP), allowing users to make telephone calls using these computerized devices. VoIP converts a user's voice to a digital signal that is then sent through the Internet to the receiving telephony system (i.e., landline telephone, other VoIP telephone, etc.). Additionally, VoIP service may be offered to individuals using historical landline POTs (Plain Old Telephony service) devices (handsets, telephones) and converting these land line signaling protocols to the VoIP digital protocol. In either architecture, the digital signal may be converted to a regular telephone POTs signal before the digital signal reaches the destination or the digital signal may be converted to the user's voice at the destination.

Emergency services (i.e., 911 services, etc.), specifically ‘Enhanced 911’ (E911), rely on location information, such as civic (street address, apartment number, etc.), provided by telephony communications systems to respond to the location of an emergency phone call. Location information of landline telephones is maintained in centralized databases. This location information is available to an emergency service operator when a call is made to the emergency services. This location information expedites the response of emergency services (i.e., personnel, vehicles, etc.) to the location of the emergency, and is invaluable when a caller, requesting emergency services, is unable to provide location information.

Recent mobile device offerings to improve their location determination and reporting now make it possible for a fixed access device, which shares a common wireless connection with the mobile device, to use the mobile location information to determine the current location of the fixed access device.

### SUMMARY

Conventional technologies for VoIP suffer from a variety of deficiencies. In particular, conventional technologies for VoIP are limited in that ‘Enhanced 911’ (E911) services are not able to accurately identify the civic (street address, apartment number, etc.) location of the stationary access device (i.e., the computerized device providing the VoIP services), if the stationary access device has been moved without notifying emergency services of the new civic (street address, apartment number, etc.) location of the stationary access device. It should be noted that a stationary access device, such as a desktop computer running a VoIP system, can be physically re-located to a new civic (street address, apartment number, etc.) location while remaining logically connected to the same network access location. A mobile device, such as a cell phone, provides the convenience of easily portability by a user.

Current VoIP access devices may be moved to different locations within a common access network. These nodes may provide services across multiple topographic (latitude, longitude, altitude) locations, and enable a user to re-locate the access device without notifying emergency services of the new location. When the access device provides local telephony services (such as a home landline), the civic (street address, apartment number, etc.) location information (stored in an emergency service database) for that access device, may be incorrect. This may result in an operator dispatching emergency services to the wrong location.

Embodiments disclosed herein significantly overcome such deficiencies and provide a system that includes a computer system executing an access device locating process within a stationary access device. The access device locating process determines the location of a stationary access device by relying on mobile devices (such as cell phones, etc.) to provide their own topographic (latitude, longitude, altitude) location information (i.e., GPS, Loran-C, cellular site triangulation, mesh node triangulation, etc.). This information is used to calculate the physical and topographic (latitude, longitude, altitude) location of the stationary access device with respect to the wireless computerized devices coverage area. Once this derived topographic (latitude, longitude, altitude) location has been determined, the stationary access device can submit this to an application server that can determine a civic (street address, apartment number, etc.) location from the topographic (latitude, longitude, altitude) location, and provide this to the stationary device, or this information can be filed in a current E911 server file. In an example embodiment, this civic (street address, apartment number, etc.) location information can then be used to dispatch emergency services to the location of the stationary access device.

Once the topographic (latitude, longitude, altitude) and civic (street address, apartment number, etc.) location of the stationary access device is determined, the stationary access device can inform non-location capable mobile devices (such as cell phones that cannot provide location information) of the topographic (latitude, longitude, altitude) and civic (street address, apartment number, etc.) location of the stationary access device. The non-location capable mobile devices may then determine their own topographic (latitude, longitude, altitude) locations, and may use the civic (street address, apartment number, etc.) location to report to emergency services

In an example embodiment, the stationary access device transmits the location of the stationary access device to an application server. The stationary access device maintains its own location information until the stationary access device receives notification to reset the location information. For example, a loss of power to the stationary access device may serve as notification to reset the stationary access device's location information. Thus, if the stationary access device is (disconnected and) moved to new location, the stationary access device will clear its previous location information, and will not provide inaccurate location information.

The access device locating process, located on the stationary access device, receives location information (associated with the mobile devices) from the mobile devices. In an example embodiment, the mobile devices discover the location services of the stationary access device using the Simple Service Discovery Protocol (SSDP). The mobile devices then may provide location information as well as wireless connection signal strength. In an example embodiment, the stationary access device receives the location information from a mobile device in an Extensible Markup Language (XML) document via Hypertext Transport Protocol (HTTP).

In an example embodiment, the stationary access device has a smart antenna that determines an angle at which the mobile device is located (with respect to the stationary access device). The access device locating process can use this angle, first, to determine both the location of the stationary access device, and then the location of a non-location equipped mobile device.

The access device locating process, located on the stationary access device, can determine the topographic (latitude, longitude, altitude) location of the stationary access device by the topographic (latitude, longitude, altitude) location information provided by a single mobile device, based on the location of the mobile device, and a signal strength associated with the mobile device as the mobile device moves to different locations. The access device locating process, located on the stationary access device can fine tune the location of the stationary access device using the location information provided by multiple mobile devices.

The access device locating process obtains a plurality of locations respectively associated with a plurality of mobile devices that are in communication with a stationary access device. For each of the plurality of mobile devices, the access device locating process obtains a relative distance metric associated with that mobile device. Based on the plurality of locations and the relative distance metric, the access device locating process computes a relative location of the stationary access device. Based on this computed relative location and topographic (latitude, longitude, altitude) location information provided by the mobile devices, the stationary access device computes its approximate topographic (latitude, longitude, altitude) location.

During an example operation of one embodiment, suppose a stationary access device, operating VoIP, is moved from a previous location to a new location. A mobile device, such as a cell phone, connects to the stationary access device using the stationary access device's physical protocol and obtains an IP address in accordance with the mechanisms and policies of the access network in which the stationary access device resides. The mobile device sends a discovery message, using an Internet Protocol (IP) protocol such as the Simple Service Discovery Protocol (SSDP), in an attempt to discover if the stationary access device or access network (associated with the stationary access device) supports a service for registering or obtaining location information. This discovery message may include any information that may be helpful to the stationary access device in determining whether the stationary access device is capable of offering a location information registration service, such as description of formats in which the mobile device can offer location information, such as GPS, Loran-C, cellular site triangulation, mesh node triangulation, civic (street address, apartment number, etc.) address, etc. The stationary access device responds to the service discovery request, and provides the information necessary for the mobile device to transmit location information in such formats that the stationary access device can accept. If the mobile device described the mobile device's capabilities in the discovery message (sent by the mobile device), the stationary access device only responds affirmatively if the stationary access device is capable of providing the service.

The mobile device formulates an XML document containing the geophysical location information that the mobile device maintains about the position of the mobile device, and transmits the geophysical location information to the stationary access device. The stationary access device adds the mobile device's location information to the stationary access device's database. The stationary access device may apply trigonometric algorithms to the data to refine the estimate of the location of the stationary access device. The stationary access device then acknowledges receipt of the location information from the mobile device. During the operation of this example embodiment, the mobile device and stationary access device exchange service discovery messages and location information messages using an appropriate IP message protocol. As described in this example embodiment, the use of SSDP and XML implies message exchange using the Hypertext Transfer Protocol (HTTP).

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include message protocols and formats to perform discovery of location services provided by the mobile devices and stationary access devices, and for the exchange of location information between the mobile devices and the stationary access devices.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein as embodiments disclosed herein.

It is to be understood that the system disclosed herein may be embodied strictly as a software program, as software and hardware, or as hardware alone. The features disclosed herein may be employed in data communications devices and other computerized devices and software systems for such devices such as those manufactured by Motorola, of Schaumburg, Ill.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows example embodiment according to one embodiment disclosed herein.

FIG. 2 shows a block diagram of a computer system according to one embodiment disclosed herein.

FIG. 3 illustrates a flowchart of a procedure performed by the system of FIG. 1 when the access device locating process obtains a plurality of locations respectively associated with a plurality of mobile devices that are in communication with the stationary access device, according to one embodiment disclosed herein.

FIG. 4 illustrates a flowchart of a procedure performed by the system of FIG. 1 when the access device locating process, based on the plurality of locations and the relative distance metric, computes a relative location of the stationary access device, according to one embodiment disclosed herein.

FIG. 5 illustrates a flowchart of a procedure performed by the system of FIG. 1 when the access device locating process receives a communication from a non location equipped mobile device, according to one embodiment disclosed herein.

FIG. 6 illustrates a flowchart of a procedure performed by the system of FIG. 1 when the access device locating process obtains a plurality of locations respectively associated with a plurality of mobile devices that are in communication with the stationary access device, according to one embodiment disclosed herein.

FIG. 7 illustrates a flowchart of a procedure performed by the system of FIG. 1 when the access device locating process obtains a plurality of locations respectively associated with a plurality of mobile devices that are in communication with the stationary access device, and establishes a communication link to a mobile device included in the plurality of mobile devices, according to one embodiment disclosed herein.

FIG. 8 illustrates a flowchart of a procedure performed by the system of FIG. 1 when the access device locating process, for each of the plurality of mobile devices, obtains a relative distance metric associated with that mobile device, according to one embodiment disclosed herein.

FIG. 9 illustrates a flowchart of a procedure performed by the system of FIG. 1 when the access device locating process, based on the plurality of locations and the relative distance metric, computes a relative location of the stationary access device, according to one embodiment disclosed herein.

### DETAILED DESCRIPTION

Embodiments disclosed herein include methods and a computer system that perform an access device locating process within a stationary access device. The access device locating process determines the location of a stationary access device by relying on mobile devices (such as cell phones, etc.) to provide their own location information (i.e., GPS, Loran-C, cellular site triangulation, mesh node triangulation, etc.). This information is used to calculate the physical and topographic (latitude, longitude, altitude) location of the stationary access device with respect to the wireless computerized devices coverage area. In an example embodiment, this topographic (latitude, longitude, altitude) location information can then be used by emergency services agencies to determine the civic (street address, apartment number, etc.) location of the stationary access device, and the civic (street address, apartment number, etc.) location thus determined can be used to dispatch emergency services to the civic (street address, apartment number, etc.) location of the stationary access device. In another example embodiment, the topographic (latitude, longitude, altitude) location is submitted by the stationary access device to an application server to obtain the civic (street address, apartment number, etc.) location of the stationary access device. The stationary access device can provide this civic (street address, apartment number, etc.) location to emergency services to enable dispatch to the civic (street address, apartment number, etc.) location of the stationary access device.

Once the topographic (latitude, longitude, altitude) location (and in some embodiments, the civic (street address, apartment number, etc.) location) of the stationary access device is determined, the stationary access device can inform non-location equipped mobile devices (such as cell phones that cannot provide location information) of the topographic (latitude, longitude, altitude) and/or civic (street address, apartment number, etc.) location of the stationary access device. The non-location equipped mobile devices may then determine their own locations. The advantages of embodiments disclosed herein include:
Dynamically provides the stationary access device location without manual data base loading
Does not require any end user or handset user activity
Centralizes data collection and reporting
Does not require simultaneous positioning calculations. Calculations may be performed on multiple position data points over time
Does not require all mobile devices to support the location information (GPS, Loran-C, cellular site triangulation, etc.). Local or roaming end devices can provide location information to the stationary access device to support several methods of triangulation calculation
Provides location information to mobile devices that may not have location services available. Provides location information to mobile devices that may have location services but for which those services are temporarily unavailable either short term or long term (i.e., no-GPS signal indoors, underground, presence of interference, etc)
Provides location information for stationary access devices and/or handsets in residential, enterprise, and metropolitan networks.

In an example embodiment, the stationary access device transmits the topographic (latitude, longitude, altitude) location of the stationary access device to an application server, for example, transmitting this information to an E911 database server. The stationary access device maintains its own location information until the stationary access device receives notification to reset the location information. For example, a loss of power to the stationary access device may serve as notification to reset the stationary access device's location information. Thus, if the stationary access device is (disconnected and) moved to new location, the stationary access device will not provide inaccurate location information.

A mobile device scans for a stationary access device with Wireless access service, such as WiFi, WiMAX, etc, and associates with it using the Wireless access service protocol. After successful association and authentication with the stationary access device the mobile device acquires an IP address for IP network connectivity. The mobile device then determines whether the stationary access device offers a location information service by sending a discovery message using the SSDP via the Hypertext Transfer Protocol (HTTP).

The access device locating process, located on the stationary access device, receives location information (associated with the mobile devices) from the mobile devices. The mobile devices may provide location information as well as a signal strength indication. In an example embodiment, the stationary access device receives the location information from a mobile device in an Extensible Markup Language (XML) document via Hyptertext Transport Protocol (HTTP).

In an example embodiment, the stationary access device has a smart antenna that determines an angle at which the mobile device is located (with respect to the stationary access device). The access device locating process can use this angle, first, to determine both the location of the stationary access device, and then the location of a non-location equipped mobile device.

The access device locating process, located on the stationary access device, can determine the topographic (latitude, longitude, altitude) location of the stationary access device by the topographic (latitude, longitude, altitude) location information provided by a single mobile device, based on the location of the mobile device, and a signal strength associated with the mobile device as the mobile device moves to different locations. The access device locating process, located on the stationary access device can fine tune the location of the stationary access device using the location information provided by multiple mobile devices.

The access device locating process obtains a plurality of locations respectively associated with a plurality of mobile devices that are in communication with a stationary access device. For each of the plurality of mobile devices, the access device locating process obtains a relative distance metric associated with that mobile device. Based on the plurality of locations and the relative distance metric, the access device locating process computes a relative location of the stationary access device.

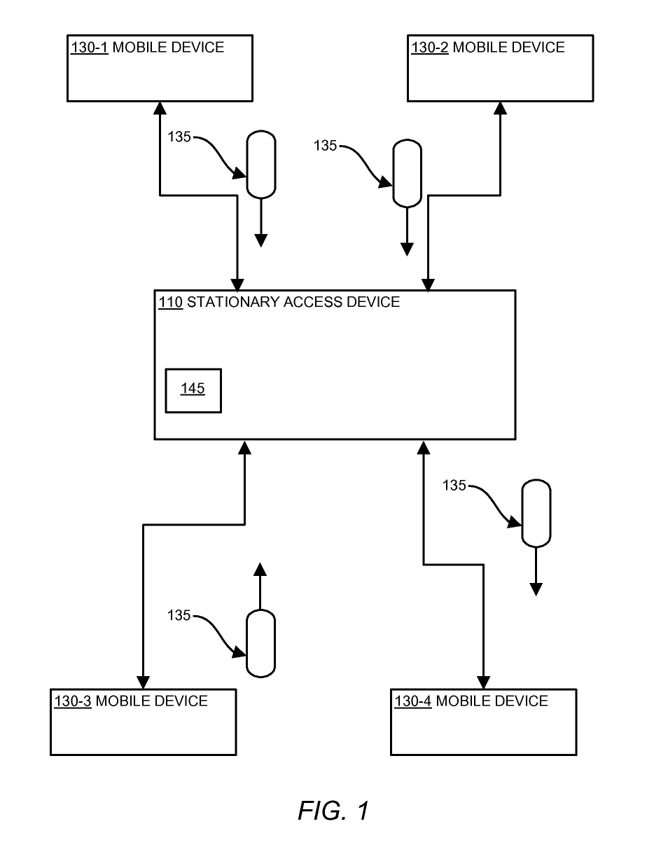

FIG. 1 is a block diagram illustrating example architecture of a stationary access device 110 executing access device locating process 145. The stationary access device 110 is in communication with a plurality of mobile devices 130-1, 130-2, 130-3 and 130-4. Mobile devices 130-1, 130-2 and 130-3 are capable of transmitting location information 135 to the stationary access device 110. Mobile device 130-4 is not capable of transmitting location information 135 to the stationary access device 110. Using the location information 135 provided by the mobile devices 130-1, 130-2 and 130-3, the stationary access device 110 computes the relative location of the stationary access device 110. The stationary access device 110 can then supply location information 135 to a non location equipped mobile device 130-4.

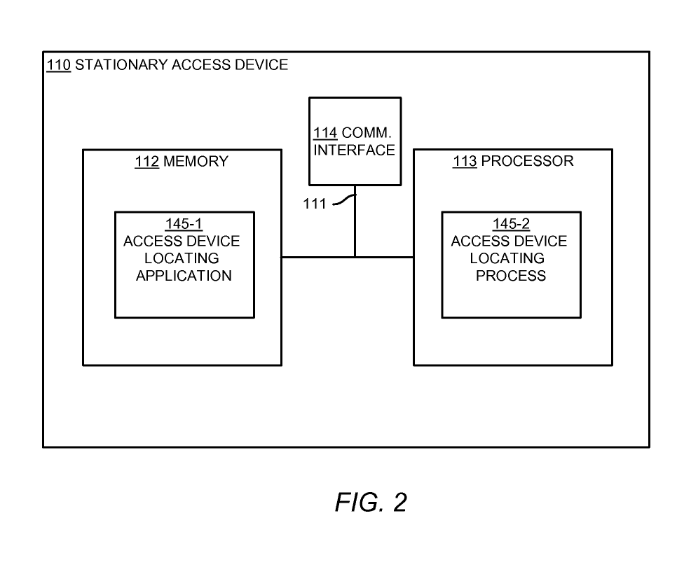

FIG. 2 illustrates an example architecture of a stationary access device 110. The stationary access device 110 may be any type of computerized device such as a personal computer, workstation, portable computing device, console, laptop, network terminal or the like. In this example, the stationary access device 110 includes an interconnection mechanism 111 that couples a memory system 112, a processor 113, and a communications interface 114. The communications interface 114 enables the stationary access device 110 to communicate with other devices (i.e., other computers) on a network (not shown). This can allow access to the access device locating application 145-1 by remote computer systems.

The memory system 112 may be any type of computer readable medium that is encoded with an access device locating application 145-1 that may be embodied as software code such as data and/or logic instructions (e.g., code stored in the memory or on another computer readable medium such as a removable disk) that supports processing functionality according to different embodiments described herein. During operation of the stationary access device 110, the processor 113 accesses the memory system 112 via the interconnect 111 in order to launch, run, execute, interpret or otherwise perform the logic instructions of the access device locating application 145-1. Execution of the access device locating application 145-1 in this manner produces processing functionality in an access device locating process 145-2. In other words, the access device locating process 145-2 represents one or more portions of runtime instances of the access device locating application 145-1 (or the entire application 145-1) performing or executing within or upon the processor 113 in the stationary access device 110 at runtime. It is to be understood that embodiments disclosed herein include the applications (i.e., the unexecuted or non-performing logic instructions and/or data) encoded within a computer readable medium such as a floppy disk, hard disk or in an optical medium, or in a memory type system such as in firmware, read only memory (ROM), or, as in this example, as executable code within the memory system 112 (e.g., within random access memory or RAM). It is also to be understood that other embodiments disclosed herein can provide the applications operating within the processor 113 as the processes. While not shown in this example, those skilled in the art will understand that the computer system may include other processes and/or software and hardware components, such as an operating system, that have been left out of this illustration for ease of description.

Further details of configurations explained herein will now be provided with respect to a flow chart of processing steps that show the high level operations disclosed herein to perform the access device locating process 145-2.

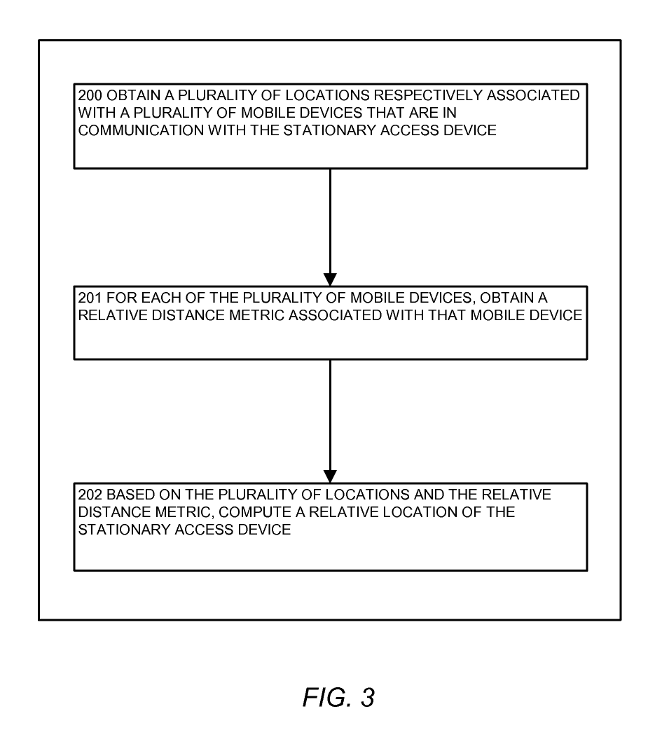

FIG. 3 is a flowchart of the steps performed by the access device locating process 145-2 when it 2 obtains a plurality of locations respectively associated with a plurality of mobile devices 130-N that are in communication with the stationary access device 110.

In step 200, the access device locating process 145-2 obtains a plurality of locations respectively associated with a plurality of mobile devices 130-N that are in communication with the stationary access device 110. Wireless access service, such as WiFi, WiMAX, Cellular, Bluetooth, etc., enables mobile devices 130-N to connect to network resources. At periodic intervals the mobile devices 130-N are capable of reporting topographic (latitude, longitude, altitude) location information 135, such as GPS, Loran-C, cellular site triangulation, etc., to the stationary access device 110. In an example embodiment, the stationary access device 110 must have a capability of:
Representing the location information 135
Determining that connected mobile devices 130-N have the capability to provide location information 135
Determining that the connected mobile devices 130-N require location information 135
Resolving conflicts between location information 135 provided by connected mobile devices 130-N
Conveying location information 135 between the stationary access device 110 and connected mobile devices 130-N

The connected mobile devices 130-N providing the location information 135 must have a capability of:
Representing location information 135
Determining that the stationary access device 110 has the capability to accept location information 130-N from the mobile devices 130-N
Submitting location information 135 to the stationary access device 110.

For each of the plurality of mobile devices 130-N, in step 201, the access device locating process 145-2 obtains a relative distance metric (i.e., distance, signal strength, time difference between signals, etc.) associated with that mobile device 130-N. In an example embodiment, the mobile devices 130-N are capable of reporting topographic (latitude, longitude, altitude) location information 135, such as GPS, Loran-C, cellular site triangulation, etc., to the stationary access device 110. The location information 135 may be used to calculate the physical and topographic (latitude, longitude, altitude) al location of the stationary access device 110 with respect to the mobile devices 130-N.

Based on the plurality of locations and the relative distance metric, in step 202, the access device locating process 145-2, computes a relative location of the stationary access device 110. In an example embodiment, the stationary access device 110 utilizes location information 135 provided by the mobile devices 130-N and the signal strength of the mobile devices 130-N to determine the location of the stationary access device 110.

In an example embodiment, a mobile device 130-1 connects to the stationary access device 110 using the stationary access device's physical protocol and obtains an IP address. The mobile device 130-1 sends a discovery message using the Simple Service Discovery Protocol (SSDP) using the Hypertext Transfer Protocol (HTTP), in an attempt to discover if the stationary access device 110 supports a service for registering location information. This discovery message may include any information that may be helpful to the stationary access device 110 in determining whether the stationary access device 110 is capable of offering a location information registration service, such as description of formats in which the mobile device 130-1 can offer location information 135. The stationary access device 110 responds to the service discovery request, and provides the information necessary for the mobile device 130-1 to transmit location information 135. If the mobile device 130-1 described the mobile device's capabilities in the discovery message (sent by the mobile device 130-1), the stationary access device 110 only responds affirmatively, if the stationary access device 110 is capable of providing the service.

The mobile device 130-1 formulates a location information message, in a format acceptable to the stationary access device location services, such as an XML document, containing the location information 135, that the mobile device 130-1 maintains, about the position of the mobile device 130-1, and transmits the location information 135 to the stationary access device 110 using HTTP to transport the message. The stationary access device 110 adds the mobile device's 130-1 location information 135 to the stationary access device's database. The stationary access device 110 may apply trigonometric algorithms to the data to refine the estimate of the location of the stationary access device 110. The stationary access device 110 then acknowledges receipt of the location information 135 from the mobile device 130-1.

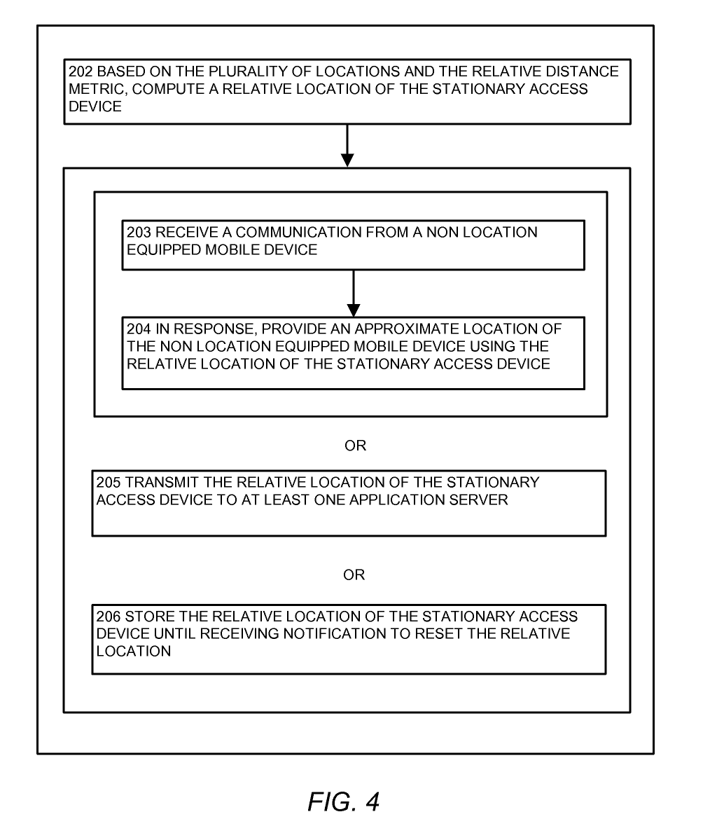

FIG. 4 is a continuation of FIG. 3 illustrating a flowchart of the steps performed by the access device locating process 145-2 when, based on the plurality of locations and the relative distance metric, the access device locating process 145-2 computes a relative location of the stationary access device 110.

In step 203, the access device locating process 145-2 receives a communication from a non location equipped mobile device 130-4. In an example embodiment, the non location equipped mobile device 130-4 discovers the location service on the stationary access device 110, and requests location information 135 (for the non location equipped mobile device 130-4) from the stationary access device 110.

In response, in step 204, the access device locating process 145-2 provides an approximate location of the non location equipped mobile device 130-4 using the relative location of the stationary access device 110. In an example embodiment, the non location equipped mobile device 130-4 must have the capability of:
Representing location information 135
Determining that the stationary access device 110 has the capability of providing location information 135
Requesting location information 135 from the stationary access device 110.

In an example embodiment, the non location equipped mobile device 130-4 connects to stationary access device 110 using the stationary access device 110's physical protocol, and obtains an IP address in accordance with the mechanisms and policies of the access network in which the stationary access device 110 resides. The non location equipped mobile device 130-4 attempts to discover, via a discovery message, if the stationary access device 110 supports a service for retrieving location information 135. The discovery message may include any information (such as description of formats in which the non location equipped mobile device 130-4 can receive location information 135 from the stationary access device 110) that may be helpful to the stationary access device 110 in determining whether the stationary access device 110 can offer a location information retrieval service.

The stationary access device 110 responds to the service discovery request, and provides the information necessary for the non location equipped mobile device 130-4 to retrieve location information 135. If the non location equipped mobile device 130-4 described its location information requirements in the discovery message, the stationary access device 110 only responds affirmatively (if the stationary access device 110 is capable of providing the service). If the non location equipped mobile device 130-4 did not describe location information requirements in the discovery message, the stationary access device 110 can describe the location information formats that the stationary access device 110 provides.

The non location equipped mobile device 130-4 retrieves the location information 135 using a uniform resource locator (URL) for an XML document containing the location information 135, provided by the stationary access device 110.

In an example embodiment, the stationary access device 110 has a smart antenna, and is able to provide location information 135 to the non location equipped mobile device 130-4 by providing both location information 135 and the angle at which the non location equipped mobile device 130-4 resides with respect to the stationary access device 110.

Alternatively, in step 205, the access device locating process 145-2 transmits the relative location of the stationary access device 110 to at least one application server. In an example embodiment, the stationary access device 110 transmits the location information 135 of the stationary access device 110 to an application server, such as an emergency services database.

Alternatively, step 206, the access device locating process 145-2 stores the relative location of the stationary access device 110 until receiving notification to reset the relative location. For example, the stationary access device 110 stores the relation location of the stationary access device 110 until a power loss to the stationary access device 110 occurs. In this scenario, when the stationary access device 110 (such as a desktop computer) is unplugged, and moved to a new location, the location information 135 stored on the stationary access device 110 is reset. Thus, the stationary access device 110 will not relay inaccurate location information 135 to, for example, an emergency services database, or a non location equipped mobile device 130-4.

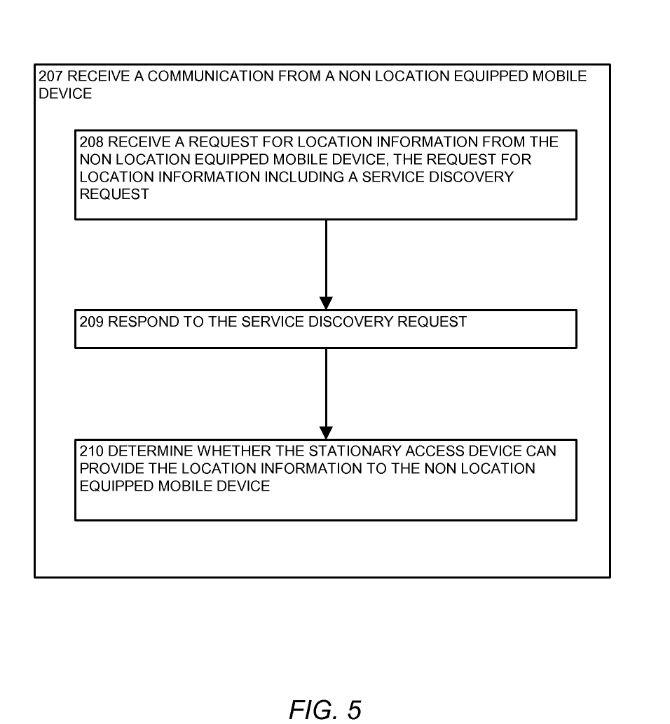

FIG. 5 is a flowchart of the steps performed by the access device locating process 145-2 when it 2 receives a communication from a non location equipped mobile device 130-4.

In step 207, the access device locating process 145-2 receives a communication from a non location equipped mobile device 130-4. In an example embodiment, the non location equipped mobile device 130-4 discovers the location service on the stationary access device 110, using Simple Service Discovery Protocol (SSDP). SSDP assumes that services make use of the Hypertext Transport Protocol (HTTP) to locate and interact with services. The non location equipped mobile device 130-4 requests location information 135 (for the non location equipped mobile device 130-4) from the stationary access device 110.

In step 208, the access device locating process 145-2, operating on the stationary access device 110, receives a request for location information 135 from the non location equipped mobile device 130-4. The request for location information 135 includes a service discovery request. In an example embodiment, the non location equipped mobile device 130-4 discovers the location service on the stationary access device 110 using the SSDP. The non location equipped mobile device 130-4 then requests location information 135 from the stationary access device 110.

In step 209, the access device locating process 145-2 responds to the service discovery request. In an example embodiment, the stationary access device 110 responds to the non location equipped mobile device's 130-4 service discovery message using the SSDP.

In step 210, the access device locating process 145-2 determines whether the stationary access device 110 can provide the location information 135 to the non location equipped mobile device 130-4. In an example embodiment, the stationary access device 110 only has location information 135 if the stationary access device 110 has registered information from a non location equipped mobile device 130-4. If the stationary access device 110 does not have location information 135 at this time, the stationary access device 110 may choose not to respond to the non location equipped mobile device's 1304 discovery request. Alternately, the stationary access device 110 could respond positively to the non location equipped mobile device's 130-4 discovery request. However, when the non location equipped mobile device 130-4 requests location information 135, the stationary access device 110 may respond with a “404 Not Found” response, and not provide an XML document for the location information 135.

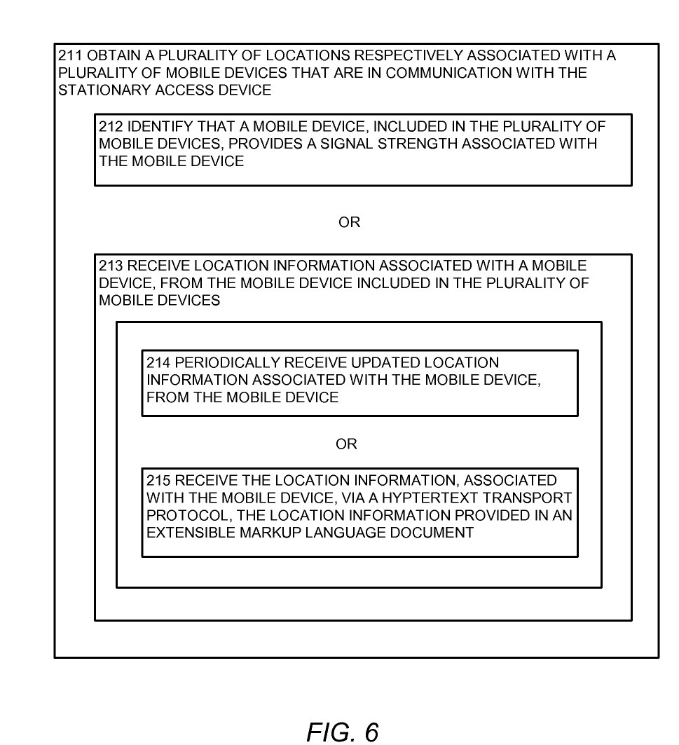

FIG. 6 is a flowchart of the steps performed by the access device locating process 145-2 when it obtains a plurality of locations respectively associated with a plurality of mobile devices 130-N that are in communication with the stationary access device 110.

In step 211, the access device locating process 145-2 obtains a plurality of locations respectively associated with a plurality of mobile devices 130-N that are in communication with the stationary access device 110. In an example embodiment, each of the plurality of mobile devices 130-N discovers a location service on the stationary access device 110 using the SSDP. The plurality of mobile devices 130-N register with location service on the stationary access device 110 using HTTP, and periodically transmit location information 135 to the stationary access device 110.

In step 212, the access device locating process 145-2 identifies that a mobile device 130-1 provides signal strength associated with that mobile device 130-1. The mobile device 130-1 is included within the plurality of mobile devices 130-N.

Alternatively, in step 213, the access device locating process 145-2 receives location information 135 associated with a mobile device 130-1, from the mobile device 130-1 (included in the plurality of mobile devices 130-N). In an example embodiment, the stationary access device 110 can determine the relative location using triangulation if the mobile device 130-1 provides both location information 135 and signal strength.

In step 214, the access device locating process 145-2 periodically receives updated location information 135 associated with the mobile device 130-1 (from the mobile device 130-1). In an example embodiment, the mobile device 130-1 periodically reports location information 135, such as GPS, Loran-C, cellular site triangulation, etc., to the stationary access device 110.

Alternatively, in step 215, the access device locating process 145-2 receives the location information 135, associated with the mobile device 130-1, via a Hyptertext Transport Protocol (HTTP). The location information 135 is provided in an eXtensible Markup Language (XML) document.

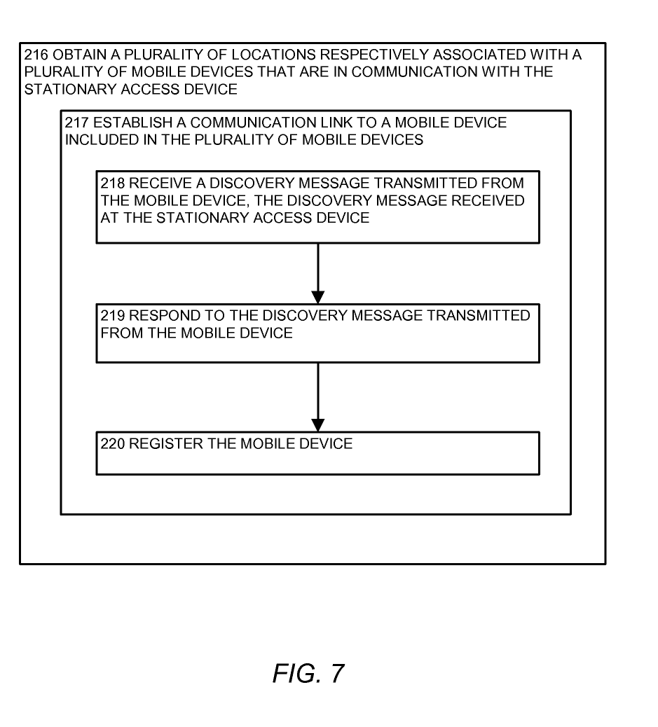

FIG. 7 is a flowchart of the steps performed by the access device locating process 145-2 when it obtains a plurality of locations respectively associated with a plurality of mobile devices 130-1 that are in communication with the stationary access device 110.

In step 216, the access device locating process 145-2 obtains a plurality of locations respectively associated with a plurality of mobile devices 130-1 that are in communication with the stationary access device 110. Wireless access service, such as WiFi, WiMAX, Cellular, Bluetooth, etc., enables mobile devices 130-N to connect to network resources. At periodic intervals the mobile devices 130-N are capable of reporting location information 135, such as GPS, Loran-C, cellular site triangulation, etc., to the stationary access device 110.

In step 217, the access device locating process 145-2 establishes a communication link to a mobile device 130-1 (included in the plurality of mobile devices 130-N). The mobile device 130-1 connects to the stationary access device 110 using the stationary access device 110's physical protocol. The mobile device 130-1 obtains an IP address in accordance with the mechanisms and policies of the access network in which the stationary access device 110 resides.

In step 218, the access device locating process 145-2, operating on the stationary access device 110, receives a discovery message transmitted from the mobile device 1301. In an example embodiment, the mobile device 130-1 attempts to discover, via a discovery message, if the stationary access device 110 supports a service for registering location information. The discovery message may include any information service (such as description of formats in which the mobile device 130-1 can offer location information) that may be helpful to stationary access device 110 in determining whether the stationary access device 110 has the capability to offer a location information registration.

In step 219, the access device locating process 145-2 responds to the discovery message transmitted from the mobile device 130-1. In an example embodiment, the stationary access device 110 responds to the service discovery request, and provides the information necessary for the mobile device 130-1 to transmit location information 135. If the mobile device 130-1 described the mobile device's 130-1 capabilities in its discovery message, the stationary access device 110 only responds affirmatively if the stationary access device 110 has the capabilities to provide the service. If the mobile device 130-1 did not describe its capabilities in the discovery message, the stationary access device 110 may describe the location information 135 formats accepted by the stationary access device 110.

In step 220, the access device locating process 145-2 register the mobile device 130-1. In an example embodiment, the mobile device 130-1 registers with the location service on the stationary access device 110 using HTTP.

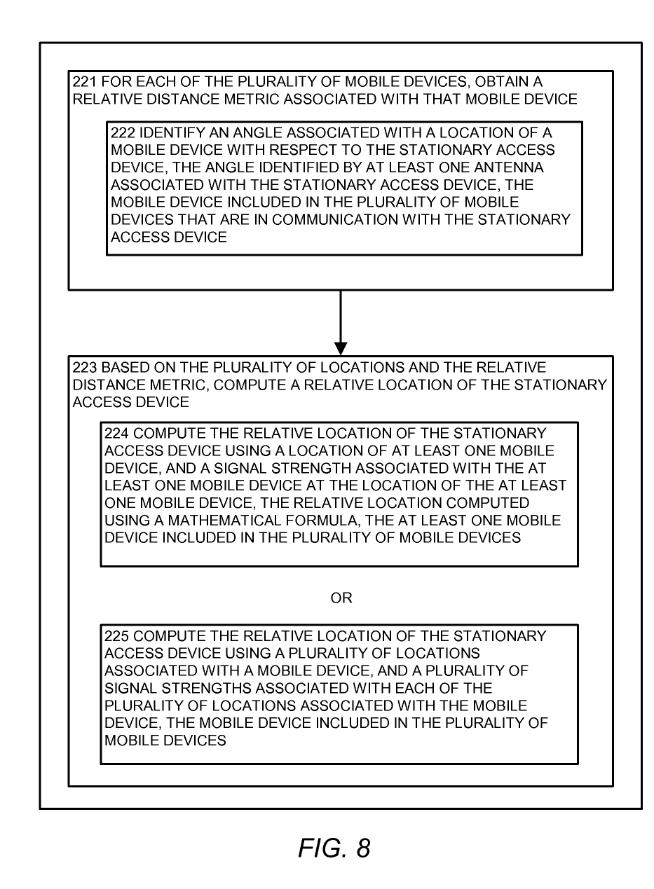

FIG. 8 is a flowchart of the steps performed by the access device locating process 145-2 when it obtain a relative distance metric associated with a mobile device 130-N for each of the mobile devices 130-N in the plurality of mobile devices 130-N.

For each of the plurality of mobile devices 130-N, in step 221, the access device locating process 145-2 obtains a relative distance metric associated with that mobile device 130-N. In an example embodiment, the mobile devices 130-N are capable of reporting location information 135, such as GPS, Loran-C, cellular site triangulation, etc., to the stationary access device 110. The location information 135 may be used to calculate the physical and topographic (latitude, longitude, altitude) location of the stationary access device 110 with respect to the mobile devices 130-N.

In step 222, the access device locating process 145-2 identifies an angle associated with a location of a mobile device 130-1, with respect to the stationary access device 110. The mobile device 130-1 is included in the plurality of mobile devices 130-N that are in communication with the stationary access device 110. The antenna, associated with the stationary access device 110, identifies the angle. In an example embodiment, the stationary access device 110 has at least one smart antenna. The access device locating process 145-2, located on the stationary access device 110, can determine the relative location of the stationary access device 110 based on the location information 135 provided by the mobile device 130-1, and the direction of the mobile device 130-1 (with respect to the stationary access device 110) as identified by the antenna.

Based on the plurality of locations and the relative distance metric, in step 223, the access device locating process 145-2, computes a relative location of the stationary access device 110. In an example embodiment, the stationary access device 110 utilizes location information 135 provided by the mobile devices 130-N and signal strength of the mobile devices 130-N to determine the location of the stationary access device 110.

In step 224, the access device locating process 145-2 computes the relative location of the stationary access device 110 using a location of at least one mobile device 130-N (included in the plurality of mobile devices 130-N), and a signal strength associated with the mobile device 130-1 (at the location of the mobile device 130-N). The relative location is computed using a mathematical formula, such as triangulation.

Alternatively, in step 225, the access device locating process 145-2 computes the relative location of the stationary access device 110 using a plurality of locations associated with a mobile device 130-1 (included in the plurality of mobile devices 130N). Each of the locations associated with a mobile device 130-1 has a plurality of signal strengths associated with each of the plurality of locations associated with the mobile device 130-1. In other words, as the mobile device 130-1 is moved from one location to another, the signal strength changes, as does the location information 135 provided by the mobile device 130-1. The access device locating process 145-2, operating on the stationary access device 110, uses the plurality of signals and the plurality of location information 135 provided by the mobile device 130-1, to determine the relative location of the stationary access device 110.

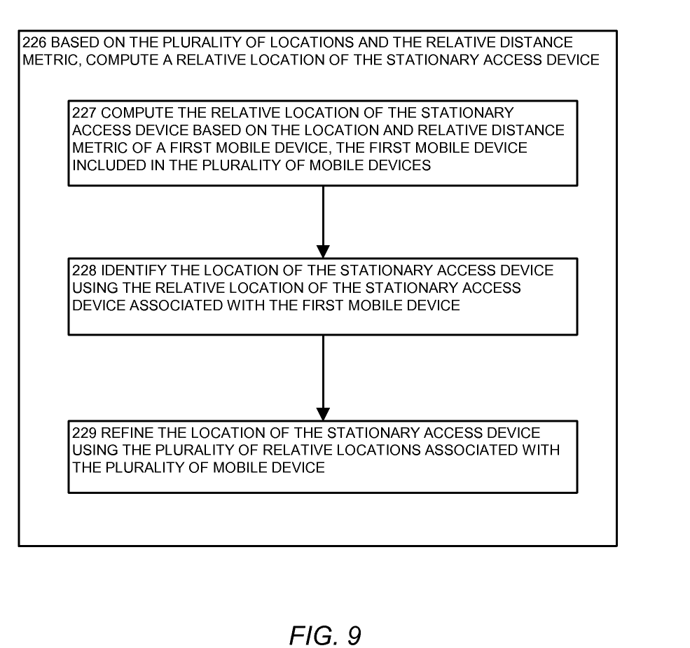

FIG. 9 is a flowchart of the steps performed by the access device locating process 145-2 when it computes a relative location of the stationary access device 110.

Based on the plurality of locations and the relative distance metric, in step 226, the access device locating process 145-2 computes a relative location of the stationary access device 110. In an example embodiment, the stationary access device 110 utilizes location information 135 provided by the mobile devices 130-N and signal strength of the mobile devices 130-N to determine the location of the stationary access device 110.

In step 227, the access device locating process 145-2 computes the relative location of the stationary access device 110 based on the location and relative distance metric of a first mobile device 130-1 (included in the plurality of mobile devices 130-1). In an example embodiment, the mobile device 130-1 transmits an XML document containing the location information 135 (associated with the mobile device 130-1) to the stationary access device 110. In this example scenario, this is the first mobile device 130-1 to transmit location information 135 to the stationary access device 110.

In step 228, the access device locating process 145-2 identifies the location of the stationary access device 110 using the relative location of the stationary access device 110 associated with the first mobile device 130-1. In an example embodiment, the mobile device 130-1 is the first mobile device 130-1 to transmit location information 135 to the stationary access device 110. The stationary access device 110 may adopt this location as the location of the stationary access device 110.

In step 229, the access device locating process 145-2 refines the location of the stationary access device 110, using the plurality of relative locations associated with the plurality of mobile device 130-N. In an example embodiment, the stationary access device 110 has registered a plurality of mobile devices 130-N. The stationary access device 110 may apply trigonometric algorithms to the location information 135 (provided by the plurality of mobile devices 130-N) to refine an estimate of the location of the stationary access device 110.

While computer systems and methods have been particularly shown and described above with references to configurations thereof, it will be understood by those skilled in the art that various changes in form and details may be made therein without departing from the scope disclosed herein. Accordingly, embodiments disclosed herein are not intended to be limited by the example configurations provided above.

What is claimed is:

1. In a stationary access device, a method for determining location, the method comprising:
obtaining a plurality of locations respectively associated with a plurality of mobile devices that are in communication with the stationary access device;
for each of the plurality of mobile devices, obtaining a relative distance metric associated with that mobile device; and
based on the plurality of locations and the relative distance metric, computing a relative location of the stationary access device.

2. The method of claim 1 comprising:
receiving a communication from a non location equipped mobile device; and
in response, providing an approximate location of the non location equipped mobile device using the relative location of the stationary access device.

3. The method of claim 2 wherein receiving a communication from a non location equipped mobile device comprises:
receiving a request for location information from the non location equipped mobile device, the request for location information including a service discovery request;
responding to the service discovery request; and
determining whether the stationary access device can provide the location information to the non location equipped mobile device.

4. The method of claim 1 comprising:
transmitting the relative location of the stationary access device to at least one application server.

5. The method of claim 1 comprising:
storing the relative location of the stationary access device until receiving notification to reset the relative location.

6. The method of claim 1 wherein obtaining a plurality of locations respectively associated with a plurality of mobile devices that are in communication with the stationary access device comprises:
identifying that a mobile device, included in the plurality of mobile devices, provides a signal strength associated with the mobile device.

7. The method of claim 1 wherein obtaining a plurality of locations respectively associated with a plurality of mobile devices that are in communication with the stationary access device comprises:
receiving location information associated with a mobile device, from the mobile device included in the plurality of mobile devices.

8. The method of claim 7 wherein receiving location information associated with a mobile device, from the mobile device included in the plurality of mobile devices comprises:
periodically receiving updated location information associated with the mobile device, from the mobile device.

9. The method of claim 7 wherein receiving location information associated with a mobile device, from the mobile device included in the plurality of mobile devices comprises:
receiving the location information, associated with the mobile device, via a Hyptertext Transport Protocol, the location information provided in an Extensible Markup Language document.

10. The method of claim 1 wherein obtaining a plurality of locations respectively associated with a plurality of mobile devices that are in communication with the stationary access device comprises:
establishing a communication link to a mobile device included in the plurality of mobile devices.

11. The method of claim 10 wherein establishing a communication link to a mobile device included in the plurality of mobile devices comprises:
receiving a discovery message transmitted from the mobile device, the discovery message received at the stationary access device; and
responding to the discovery message transmitted from the mobile device; and

12. The method of claim 11 comprising:
registering the mobile device.

13. The method of claim 1 wherein obtaining a relative distance metric associated with that mobile device comprises:
identifying an angle associated with a location of a mobile device with respect to the stationary access device, the angle identified by at least one antenna associated with the stationary access device, the mobile device included in the plurality of mobile devices that are in communication with the stationary access device.

14. The method of claim 1 wherein computing a relative location of the stationary access device comprises:
computing the relative location of the stationary access device using a location of at least one mobile device, and a signal strength associated with the at least one mobile device at the location of the at least one mobile device, the relative location computed using a mathematical formula, the at least one mobile device included in the plurality of mobile devices.

15. The method of claim 1 wherein computing a relative location of the stationary access device comprises:
computing the relative location of the stationary access device using a plurality of locations associated with a mobile device, and a plurality of signal strengths associated with each of the plurality of locations associated with the mobile device, the mobile device included in the plurality of mobile devices.

16. The method of claim 1 wherein computing a relative location of the stationary access device comprises:
computing the relative location of the stationary access device based on the location and relative distance metric of a first mobile device, the first mobile device included in the plurality of mobile devices; and
identifying the location of the stationary access device using the relative location of the stationary access device associated with the first mobile device.

17. The method of claim 16 comprising:
refining the location of the stationary access device using the plurality of relative locations associated with the plurality of mobile device.

18. A computerized device comprising:
a memory;
a processor;
a communications interface;
an interconnection mechanism coupling the memory, the processor and the communications interface;
wherein the memory is encoded with a access device locating application that when executed on the processor is capable of determining location on the computerized device by performing the operations of:
obtaining a plurality of locations respectively associated with a plurality of mobile devices that are in communication with the stationary access device;
for each of the plurality of mobile devices, obtaining a relative distance metric associated with that mobile device; and
based on the plurality of locations and the relative distance metric, computing a relative location of the stationary access device.

19. The computerized device of claim 18 the computerized device performs the operations of:
receiving a communication from a non location equipped mobile device; and
in response, providing an approximate location of the non location equipped mobile device using the relative location of the stationary access device.

20. A computer readable medium encoded with computer programming logic that when executed on a process in a computerized device determines location, the medium comprising:
instructions for obtaining a plurality of locations respectively associated with a plurality of mobile devices that are in communication with the stationary access device;
for each of the plurality of mobile devices, instructions for obtaining a relative distance metric associated with that mobile device; and
based on the plurality of locations and the relative distance metric, instructions for computing a relative location of the stationary access device.
